(19) United States
(12) Patent Application Publication
(10) Pub. No.: US 2017/0235009 A1
(43) Pub. Date: Aug. 17, 2017

(54) Metal detector using coils with multiple detection zones to identify targets while moving

(71) Applicant: Glenn Curtis Arrant, Valley Center, CA (US)

(72) Inventor: Glenn Curtis Arrant, Valley Center, CA (US)

(21) Appl. No.: 15/042,141

(22) Filed: Feb. 11, 2016

(51) Int. Cl. G01V 3/10; G01V 13/00

(52) U.S. Cl. CPC G01V 3/101; G01V 13/00

(57) ABSTRACT

A metal detector with multiple detection zones of alternating polarity achieved by means of multiple coil windings such that when a target moves across it, a detection signal of alternating polarity is generated with a waveform shape which replicates the pattern of zones, a distinctive detection waveform which enables enhanced recognition of target presence while in motion. Balance to external EMI enables the use of large coils for non-swinging searching at high area searching rates.

### RELATED APPLICATIONS

This application claims the benefit of priority under 35 USC §119 of U.S. Provisional Application Ser. No. 62/115,553, dated Feb. 12, 2015, the entire disclosure of which is incorporated herein by reference.

### TECHNICAL FIELD OF THE INVENTION

This invention relates to the field of metal detectors.

### BACKGROUND OF THE INVENTION

Most hobby metal detectors today are based on a swinging disk design which limits their search rates to around 5 square feet per second, making them effective for small target-rich areas but not for sparse target areas such as open deserts, woodlands, remote beaches, large washes, and dry river beds where targets may be considerably farther apart, resulting in long times between target detections. The need for larger search coils to speed searching is great enough that specialty coil manufacturers have proliferated to provide larger coils to increase the coverage area per swing by approximately a factor of 2. Even larger coils are needed to improve area search rates for sparse target areas.

New metal detector users often complain of arm discomfort after 10 minutes of metal detecting until arm strength is built up. Some older users even leave the hobby due to wrist, arm, and back pain. To alleviate these, manufacturers are bringing metal detector weight down. Suppliers are providing hip belt mounts and shoulder straps to support metal detector weight. There is a need for a lower body stress metal detector system.

Treasure hunters are demanding large deeper seeking coils. These as well as the larger swing type coils are experiencing increasing desensitization due to not only wider spread and dilution of the exciter power, but also degradations due to electromagnetic interference (EMI) in the 4 kHz to 100 kHz frequency ranges used by sensitive frequency domain and impulse type metal detectors. Power line synchronous EMI sources such as fluorescent lights, light dimmers, insulator leakage, electric motors, etc. are common interferers although at times the video screens and switching power supplies of electronic equipment and impulse emissions of gasoline engines can be a problem. High power broadcast stations in the 1 MHz region cause desensitization in broadband metal detectors such as impulse types.

Recently EMI-balanced coils and numerical processing algorithms and even automatic adaptive selection of EMI reduction methods have appeared, helping to alleviate EMI problems, but this has not brought forward a more convenient method of metal detecting.

### BRIEF SUMMARY OF THE INVENTION

A metal detector of the present invention includes a detection surface with multiple detection zones of alternating polarity such that a target going under the metal detector generates a detection signal of alternating polarity as the target passes through the detection zones. This dynamic waveform has a shape which matches that of the coil zone sequence, thus providing a recognizable pattern from which a visual indicator or numerical processor can easily identify the passage of a target. It is possible to identify the material type and depth using this method while forward searching and without stopping, providing a high speed and low exertion search method without swinging the coil head.

One embodiment of the invention is a coil arrangement with two detection coils of several feet width as a metal detector head to be mounted on a pole held in front of the user as the user walks forward either observing a bipolar bar graph indicator or listening to an FM tone whose frequency indicates the amplitude of the detection signal, moving one way in frequency for a positive response and the other way in frequency for a negative response.

The positive and negative detection zones span the full width of the head and are several inches in width, one covering the front three inches at the leading edge of the head and the other covering the back three inches at the trailing edge. As the user walks over a target the detection signal rapidly rises in amplitude in one polarity then abruptly ramps through zero to an equal amplitude peak of the other polarity and then back to zero. This abrupt dual peak waveform, referend to here as a doublet, is seen on two parallel bar graphs, one indicating upward for increasing positive detection voltage and the other next to it indicating upward for increasing negative detection voltage. At a walking speed of 3 miles per hour and a 3 inch separation between the front and rear zones, the time between peaks is just 56 ms.

The eye is surprisingly sensitive to the resulting bar graph pattern which is a quick double flash, the hallmark of an object going under the two zone coil. Because the bars are separated left and right the effect is a bright flash going from left to right or right to left, the sideways movement again a recognizable feature of the two coil double flash. In practice it is found that having the rapid transition and twice the peak to peak amplitude compared with the customary single polarity detector allows excellent recognition of targets in noisy environments such as over soil with high iron concentration variation and also when operating near the metal detector noise threshold.

The same double-flash detection may be done using numerical methods, correlating with doublets of various peak time separations, or by recognizing features such as the two equal amplitude but opposite polarity peaks or the slope in front of the first peak, much steeper slope between the peaks, and the slope after the second peak.

The multiple zone detection system has several advantages which are listed below.

The arrangement of positive and negative detection coils provides the opportunity to achieve a nulling of sensitivity to electromagnetic interference (EMI) fields.

The exciter coil may be arranged over the detection coil such that the exciter signal is nulled at the detection signal output.

Addition of more zones of various widths provides increasing recognizability to see objects within a slowly varying concentration of soil features.

Since the detection waveform is the difference between the detection of the two zones, soil variations which vary over a length greater than the coil separation, in the example case 3 inches apart are nulled to a great extent.

For a frequency domain detector, phase of the detection signal may be assessed at both the positive and negative peaks to indicate the material type while the user is moving, increasing speed and lowering exertion.

By using two different detection zone widths, recognition of the ratio of the two peak amplitudes can be used to estimate the object's depth to around 30% accuracy.

Compared to monopolar detection, the doublet waveform leaves a much smaller residual offset in the AC coupling process, eliminating the residual false target indication after a pass over an object.

The wide two zone head can be placed widthwise for low effort forward searching or placed along the line of search to use as a wide swath swing type detector.

Because the detection method requires motion, the system is applicable to towing by or attachment to a small vehicle such as a bicycle or small recreational vehicle.

### BRIEF DESCRIPTION OF THE SEVERAL VIEWS OF THE DRAWINGS

The accompanying drawings, which are incorporated herein and constitute part of this specification, illustrate exemplary embodiments of the invention, serve to explain the features of the invention, and indicate features whose nomenclature is defined within the referencing text.

FIG. 1 shows a block diagram of a multi-zone coil including exciter, a multiple zone detection surface, The bipolar detection signal, detection processor, and target strength indicator.

FIG. 2 shows the preferred implementation of the multi-zone coil with just two detection zones.

FIG. 3 shows the double-flash response of the 2-zone detection coil as seen on a dual polarity detector.

FIG. 4 shows the double-flash response of the 2-zone detection coil as seen on a mono-polarity detector.

FIG. 5 illustrates an exciter coil balanced to eliminate emissions to nearby metal detectors.

FIG. 6 shows a vector representation and the In phase and quadrature components of response vectors for 6 different metal objects.

FIG. 7 shows the same measurements including all the responses of a dual polarity detector.

FIG. 8 shows the same measurements after rotation to put positive responses on the right and negative responses on the left.

FIG. 9 shows summing of coil responses using series connection of the detection coils.

FIG. 10 shows the same coil function as FIG. 9 but with parallel wired summing.

FIG. 11 shows an analog summing of separate detection sub-coils.

FIG. 12 shows separate digitizing of separate detection sub-coils and summing done by numerical means.

FIG. 13 shows a 4-zone coil head which generates a very distinctive pattern, enhancing target recognition using numerical methods for pattern recognition.

FIG. 14 presents a 2-zone pattern which provides indication of target depth.

FIG. 15 shows the field around an exciter coil having opposite directions in the center of the coil and outside its perimeter.

FIG. 16 shows coil positioning for one exciter coil and two detection coils using reversal of the field direction outside the exciter coil to create a 4-zone detection surface.

FIG. 17 shows the AC-coupled detection response for a single polarity detector.

FIG. 18 shows the AC-coupled detection response for a dual polarity detector.

### DETAILED DESCRIPTION OF THE INVENTION

### Definition of Terms

Metal Detector—

An electronic instrument using magnetic fields to detect the presence of metal objects, either in view or hidden by moving a sensor near the area of the object and noting the strength of an indication signal.

Target—

A term for an object being seeked or being detected by a metal detector.

Detection Area—

The planform area of the array of excitation and detection coils of a metal detector. Targets generally pass under the detection area, causing disruption of the magnetic fields generated by the coils near the target.

Long Detection Surface—

A detection area which is longer than it is wide much like a narrow board.

Orthogonal—

At right angle to, or crosswise to. For example a user walking forward may use long sensing head which extends out to the right and left at right angles to, or orthogonal to, the direction of travel.

Alternating Polarity Composite Detection Signal—

A detection coil provides an electrical signal when a target goes under it. If the coil is then wound in the opposite direction or connected backwards, the detection signal remains the same but is inverted in electrical polarity. When a target moves for coil to coil and the polarities are connected in alternating polarities, the detection signals goes positive and negative depending on which coil it is under.

Exciter Coils—

These are the coils that create a magnetic field which the target goes through and disturbs.

Excitation Signal Waveform—

This is the signal provided to the excitation coil. For frequency domain detectors it is a sine wave signal waveform and for impulse type detectors it is a pulse waveform.

Detection Coils—

These are the coils which detect the magnetic field from the exciter coils. When the target passes underneath the fields change and the detection signal changes, allowing detection by electronic detectors and processors.

Nulling—

Detector coils are usually arranged to have their different parts arranged near different parts of the exciter coils, some in positive polarity and some in negative polarity so that when summed, the exciter signals cancel out or null, thus not masking the small signals from the targets.

I and Q Vector Representation

An exciter generates a sine wave as an excitation signal and a second sine wave shifted in time by 90 degrees, referred to as the quadrature signal. The two may be scaled in magnitude and sign to create a third sine wave of any desired magnitude ad phase. The detectors in most metal detectors converts a detected sine wave back into its I and Q components. The I and Q vector representation uses a graph to plot the I value horizontally and the Q value vertically. The length of the line representing the detected sine wave represents it magnitude and its phase shift is represented by its angle with respect to the horizontal axis. The vector diagram reduces much mathematical processing to into graphical manipulation, simplifying the complexities of the signal processing.

Detection Zones—

Exciter and detection coil boundaries break the detection surfaced into multiple zones which have the same detection polarities. When a coil boundary is crossed, the polarity changes causing adjacent zones to have different detection polarities.

Scale Factors—

When the signals of several coils are summed their signals may be selectively multiplied by a numerical factor called the scaling factor which is unity to maintain the same amplitude or greater than one to enlarge the signal or less than 1 to reduce it. A negative sign on the scaling factor cause the signal to also be inverted in polarity. Adjustment of scaling is useful when attempting to null s signal from two sources, one positive and one negative, where an exact match of amplitudes is necessary to maintain a very small remainder.

EMI Balance Command

The front panel of the metal detector may be fitted with this button which causes the metal detector to adjust coil gains to null the overall response to external interfering signals.

Bar Graph—

A sequential array of lights, typically LED's, where all of them are off to represent a zero as the signal level increases more lights glow with lights added starting at one end to provide an image much like a thermometer whose lit length indicates the magnitude of the signal.

Dynamic Visual Indicator of the Magnitude and Polarity—

A visible indication of signal level variation such as a meter with a needle which is centered for a signal level of zero and deflects to the right for an increasing level positive signal and to the left for an increasing magnitude negative polarity signal.

Dynamic Audible Indicator of the Magnitude and Polarity—

This could be a tone at a fixed frequency for a signal level of zero and rises in frequency for an increasing positive signal and is lowered in frequency for an increasingly negative signal.

Numerical Processing Function—

Conversion of signals into a sequence of its voltage over time and subsequent computer processing of the numbers according to mathematical algorithms to generate numbers which reveal key characteristics of the signals such as their average amplitude, rate of change of amplitude, and much more.

Material Type—

A metal detector can identify metal type and thickness from the target's effect on the magnetic field of the exciter coils as sensed by the detection coils.

Depth—

The level of a hidden object below the surface of the ground.

Correlation—

A mathematical algorithm to compute the level of similarity between a detected waveform and a stored waveform.

Relative Target Movement—

Motion between the coils and the target whether the coils are moving over the target or the target is moving past the coils.

Forward Searching—

Doing metal detection by walking forward and holding the coil over the ground without swinging it. A forward searching coil provides rapid area searching because of the width of the detection surface.

Frequency Domain Detection—

Using an excitation which is a sine wave.

Pulse Detection

Using an excitation which is continuous series of impulses.

### Description

The invention is a metal detector using exciter and detection coil positioning to produce a detection area with zones of opposite polarity indications. This means for a pulse type detector the detected pulse is in a positive polarity in some zones and a negative polarity in other zones. For a frequency domain detection method, the sine wave detection waveform when a target is present is at one angle in some zones and with a 180 degree phase shift in other zones. The detector in each case must be able to sense both the magnitude of the detected signal and the polarity as well.

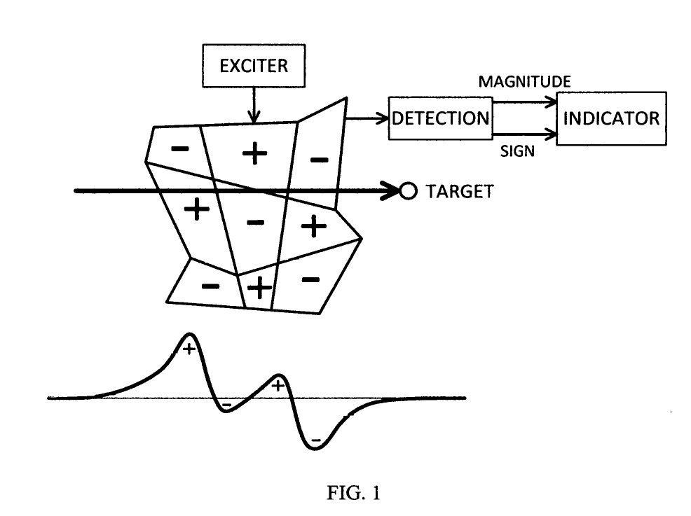

FIG. 1 shows a detection zone area in the general case with several detection zones. The target moving with respect to the coils as shown passes sequentially through several zones of opposite polarity thus creating the detection voltage shown, a pattern which matches the pattern of the zones it has traversed. Peaks are largest when near the center of a detection zone and smallest when near a border between opposite polarity detection zones.

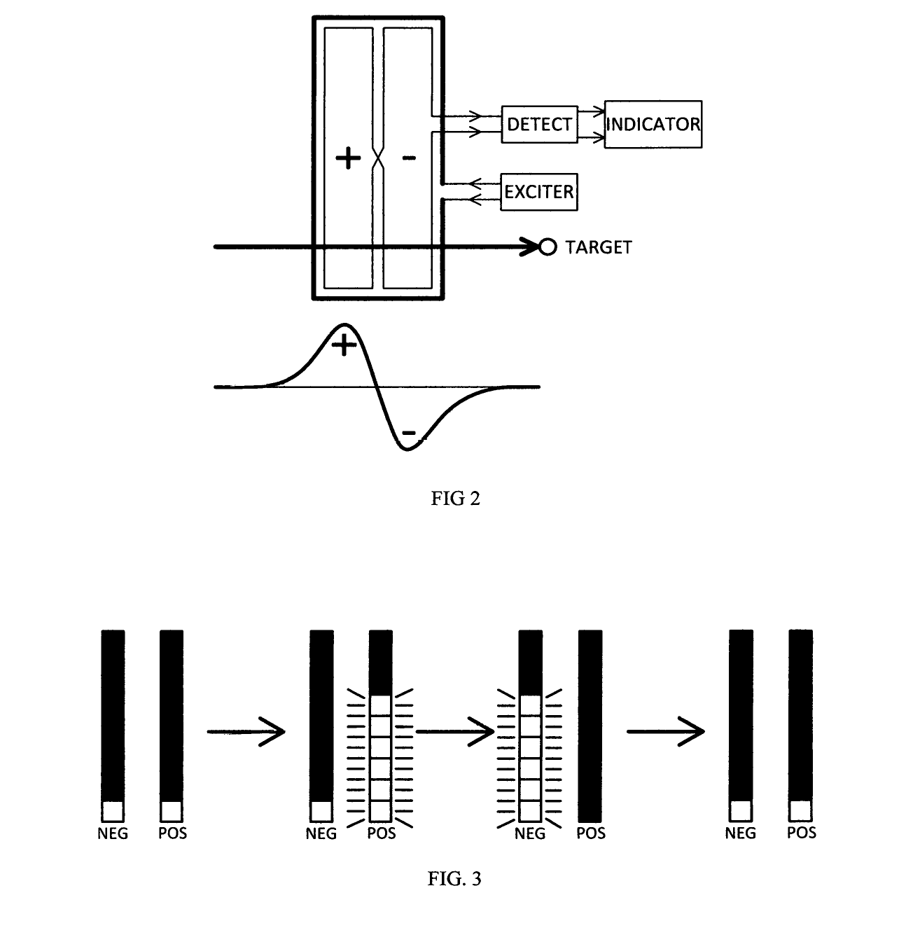

FIG. 2 shows the preferred implementation of the multiple detection zone configuration for a frequency domain detector using a single exciter coil and a double detection coil with the two detection coils connected in series with opposite coil detection polarities. Opposition is easily checked by noting that a current through the coil pair rotates in one direction for one coil and the other direction for the other coil. This example may be recognized as a gradiometer, a sensing coil sensitive only to the difference in magnetic fields of the two detection coils, thus being sensitive to the magnetic signal gradient, hence the term gradiometer. As the target travels under the coils, the voltage response of FIG. 2 is detected.

This simple configuration has two benefits shared by many other multiple zone coil configurations. First, there is no detection response to uniform externally generated EMI fields because uniform fields induce the same voltages in the two detection coils which are connected in opposition, thus canceling the detected EMI signals. This is especially important for large coils with their large areas intercepting considerable EMI energy, the interference from which sets a highly restrictive limit to detector sensitivity.

Second, by symmetry the exciter coils induce the same voltages in the two detection coils which are connected in opposition, thus nulling the exciter signal content in the detected output. Again, imbalance to the exciter signal sets a lower limit to sensitivity because of the large excitation fields injected into the detection coils which may be only a fraction of an inch from the exciter coils.

The dual bar graph of FIG. 3 provides a surprisingly recognizable indication when a target goes under the coil. As shown, first the right side of the indicator lights up and halfway through the waveform suddenly the light transfers to the left side. This very distinctive and eye catching double flash is the hallmark of the 2-zone coil. Because the double flash appears to travel from one bar graph to the other, the double flash is perceived by the eye as a rapidly moving light, traveling from right to left, dramatically unlike the slow wandering response caused by variations in ground mineralization. This type of visual indicator with separate positive and negative indication is referred to here as a bipolar indicator.

Tone frequency modulation can also indicate the doublet waveform, droning at a constant pitch and then going low in frequency and then high and then back to the drone frequency, a transition referred to as a “low-high” transition. A “high-low” transition has a different audible feel but is still as distinctive.

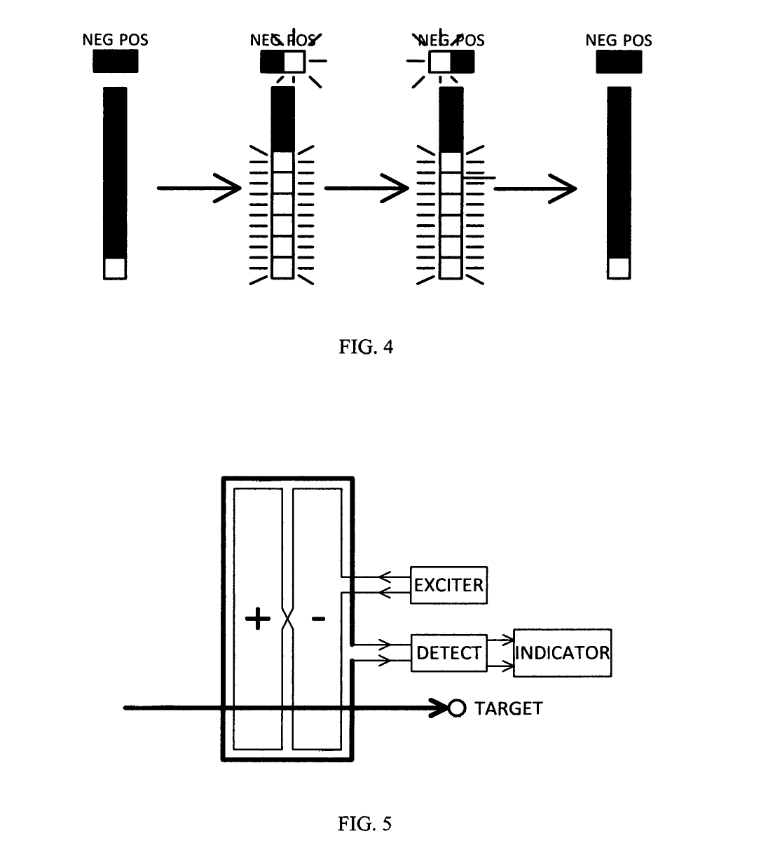

For a monopolar indicator such as shown in FIG. 4, only the amplitude information is used as shown. A double peak results, but without the large slope between a positive and a negative peak, the waveform is half the size in amplitude and much more difficult to discern visually or aurally near the noise limit of the detector. The sign indicator is almost useless because while it flashes rapidly to the left or right when a target passes under the coil, it is also continually flashing when no target is present due to the noise floor of the detection system.

FIG. 5 shows another arrangement using the same coils with the exciter and detection functions reversed. In this case the detection system is not balanced to EMI because there is only one detection coil. However, the exciter is now balanced to EMI which has little value from a detection standpoint, but in the exciter role exciter fields cancel at some distance from the exciter coils, reducing interference to other nearby metal detectors.

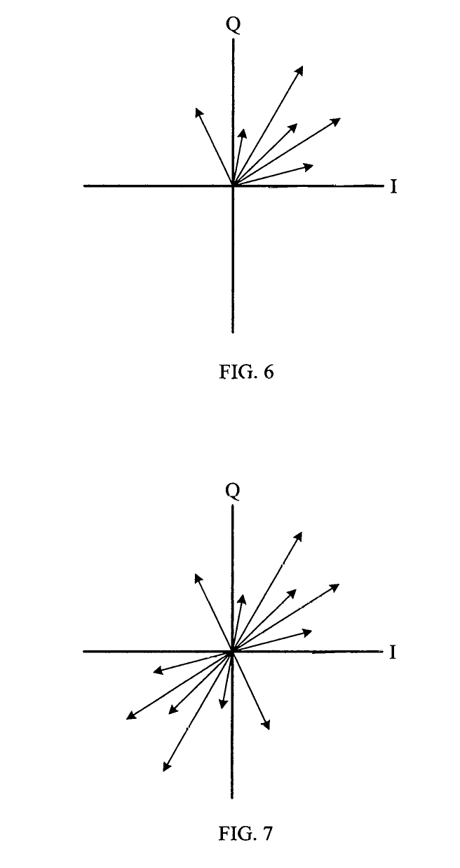

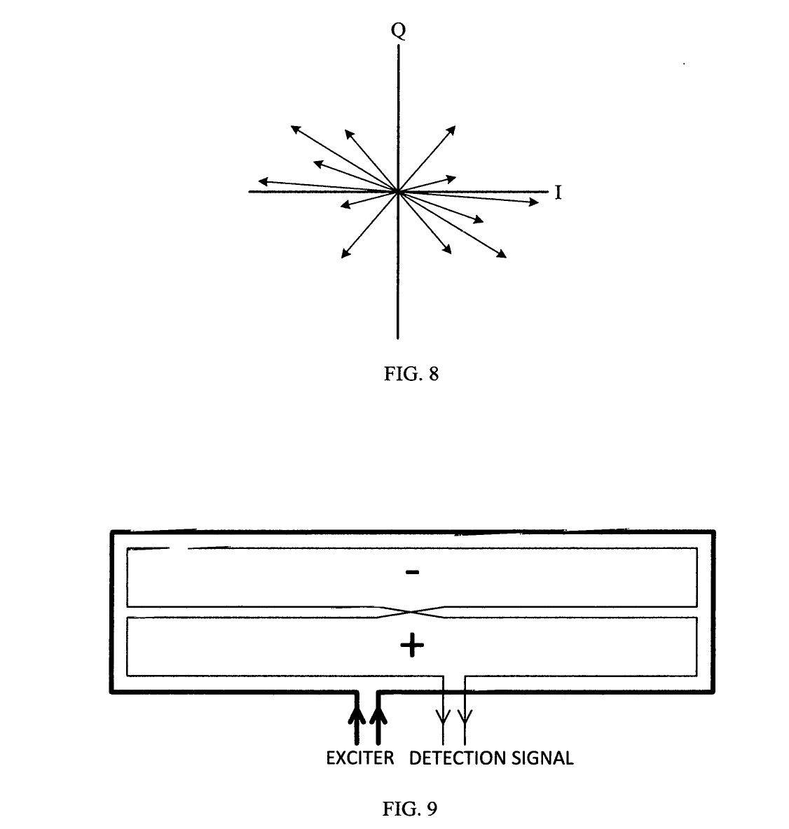

For the frequency domain detector using numerical processing the typical detection method is to numerically separate the sine wave sampled by the analog to digital converter into its in-phase and quadrature components using the exciter drive as a timing reference. FIG. 6 shows the I and Q vector representation of the I/Q detector for several metallic objects. As can be seen the detected sine wave angle varies across a range of around 120 degrees as materials from iron to highly conductive metals are encountered. FIG. 7 show the same measurements taken with a coil with both positive and negative indications. This shows the problem of deciding if the signal is upright or inverted, an error in that decision causing an incorrect material identification. This can be resolved by rotating the vector by a fixed amount to place those responses along the I-axis, leading to a plus and minus 60 degree variation between materials as shown in FIG. 8. In this orientation the sign of the I-axis value indicates the polarity of the signal. To provide an accurate angle measurement for material assessment, if the indication is negative, 180 degrees may be added to the measurement angle to reveal the actual angle. This is done numerically by changing the sign of the I value and the sign of the Q value.

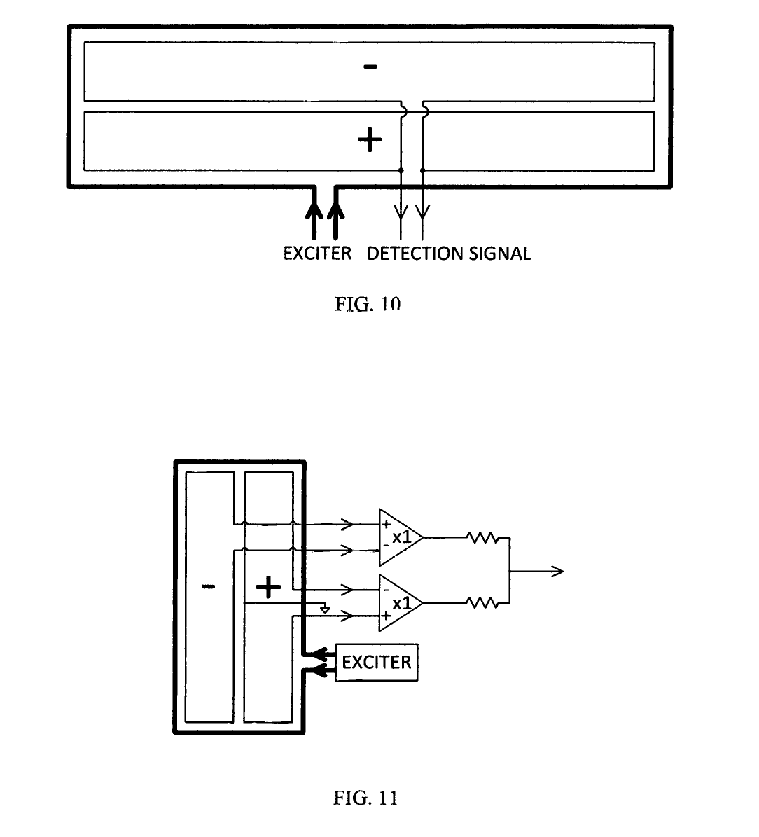

Critical to this invention is the scaling and summing of signals from the multiple detection coils of different polarities. FIG. 9 shows summing through series connection of the coils. FIG. 10 shows a parallel connection method which achieves a similar result. For coil heads with many detection sub-coils, a combination may be used. The series connection is preferred because the result is the simple sum of coil voltages whereas paralleling the coils results in detected voltages which are also a function of the relative impedances of the coils.

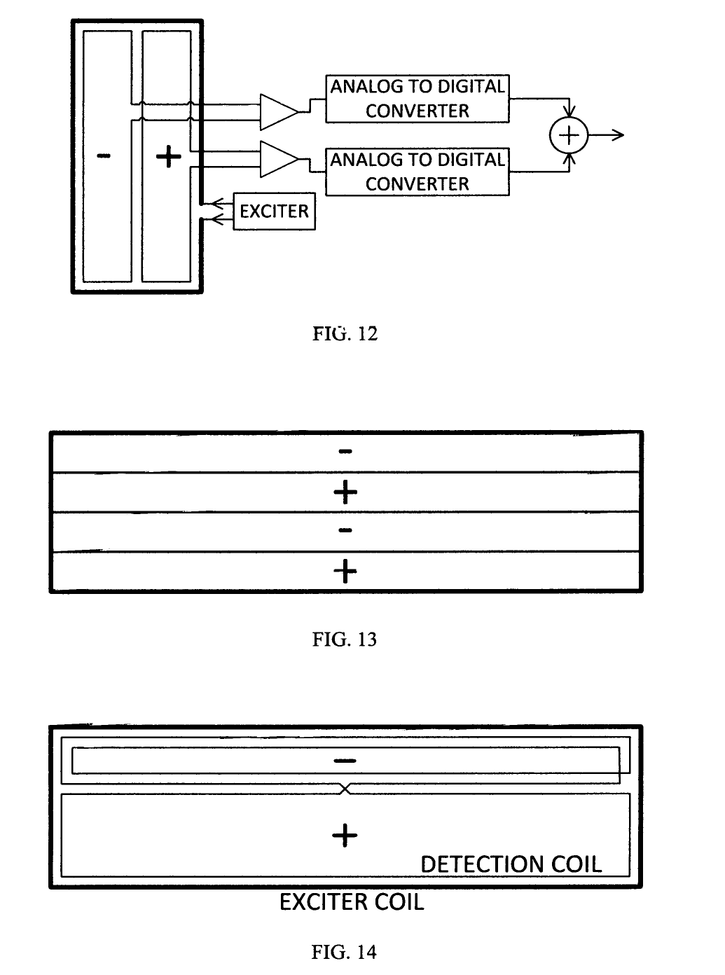

FIG. 11 shows analog summing of the detection coil signals. This has the advantage that an exact balance to EMI fields can be achieved by trimming the relative gains of the coils through adjustment of trim potentiometers. An electronically controllable potentiometer may also be used for automatic EMI nulling. FIG. 12 shows the same function achieved numerically.

Automatic nulling of EMI may be accomplished by automatically adjusting relative detection coil gains to minimize EMI signal levels on the composite detection signal. This process may be continuous, periodic, or initiated by the user. The EMI content may be found by blanking the exciter signal during the EMI analysis period. Such a process must generally detect EMI for at least one power line cycle to detect and correct or blank all impulses generated across the power line cycle time. These impulses are caused by ignition of fluorescent light bulbs, firing of solid state switches in dimmer circuits and power converters, discharge from leaky power line insulators and other power-line related phenomena.

Automatic EMI adjustment has the advantage over fixed nulling when operating near an EMI source which is close enough that the EMI field is slightly stronger in the nearer coils than in the coils farther away from the EMI source. Typical near sources include ground-mounted power transformers, generators, digital video displays, and gas engine ignition systems.

Many bipolar detection zone patterns may be formed using various exciter and detection coil layouts as shown in FIGS. 13 and 14. The pattern of FIG. 13 is referred to here as a zone code pattern. The use of zone coding, especially a long code with many zones, can potentially provide enhanced detection with great positional accuracy in harsh detection environments. As with many of the methods described here, numerical methods are the most practical approaches for the computation involved.

FIG. 14 shows an example of a two zone arrangement using two different coil widths to provide an indication of target depth. This works because the two coils have a different rolloff of sensitivity with target depth, the narrower coil having a sensitivity which rolls off faster with depth. The narrow coil loses sensitivity more rapidly with depth, the ratio between the two readings providing a fair indication of target depth. Note that while the narrow zone has half the area of the wide zone, it has twice the number of turns, providing equal sensitivity to uniform fields for the two coils, preserving EMI balance with the two coil outputs connected in opposite polarity.

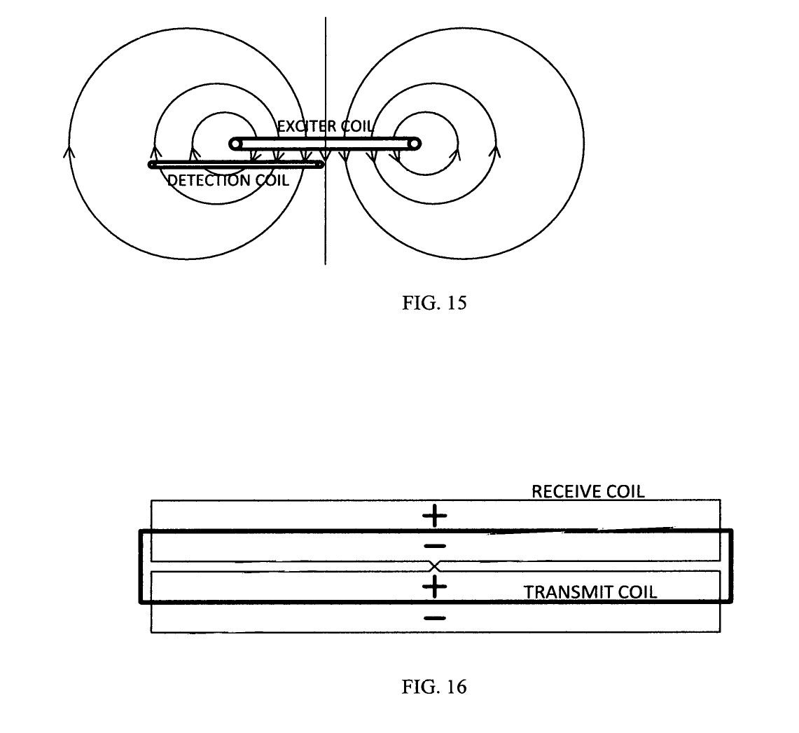

FIG. 15 shows how field lines circle around a coil edge, the field pointing downward inside the coil and upward outside the coil. This provides an opportunity for coils along the perimeter of a exciter or detection coil set to create opposite polarity zones without adding an additional coil. FIG. 16 shows an example of using the extended fields at coil edges to create additional zones.

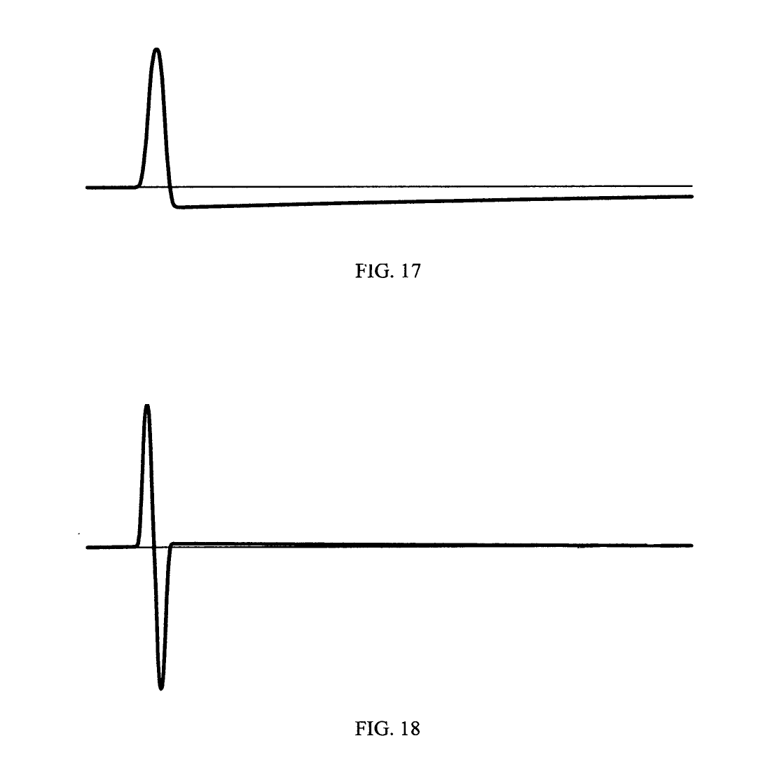

A monopolar detector on most coils normally provides a single detection pulse as shown in FIG. 17. This tends to place an offset into the AC coupling circuit which must die out as shown before full sensitivity returns. However, the average value of the doublet is zero and little residual offset is induced in the AC coupling circuit as shown in FIG. 18, greatly reducing residual effects of target detection.

It was found that although the two coil head configuration is optimized for dynamic searching, the head could be rocked up on the forward coil to use as a static searcher to statically pinpoint targets without doing a forward search. Material type may also be read using this static technique.

The very sharp null at the line between the two zones allows location of the center of a target within a fraction of an inch. Finding the target center in two directions with about a 90 degree rotation between them enables locating a target with such accuracy that a minimum of digging is needed.

The invention is intended primarily for hand-held operation but early development was done using a large head in a vehicle-towed arrangement. However, subsequent analysis showed that safety factors were insufficient for use by the general public due to lack of visibility of the operator by the driver. Positive visibility of the operator by the driver could be assured only with a small vehicle such as a small all-terrain vehicle or bicycle.

1. A metal detector capable of identifying a target presence and/or composition within a detection area by means of an alternating polarity composite detection signal, said detector comprising:
a. one or more exciter coils driven with a common excitation signal; and
b. one or more detection coils, each producing a coil detection signal; and
c. said exciter coil or said detection coil or both comprising a multiplicity of coils of alternating polarity;
wherein said alternating polarity composite detection signal is produced by dispositioning said excitation coils and said detection coils in an overlapping configuration, such that:
d. said detection area is divided into a set of detection zones of opposite signal polarity response; and
e. said responses form a recognizable pattern that corresponds to the sequence of the detection zones.

2. The metal detector of claim 1, wherein said a detection coil signals are scaled and summed in an arrangement which nulls the composite signal response to an externally generated field.

3. The metal detector of claim 1, wherein said excitation signal is nulled within said composite detection signal.

4. The metal detector of claim 1, further comprising a dynamic visual or audible indicator of the magnitude and polarity of said composite detection signal.

5. The metal detector of claim 4, wherein said indicator is a separate bar graph for each signal polarity or, alternatively, a visual display comprising a bar graph to depict magnitude and a signal polarity identifier.

6. The metal detector of claim 1, wherein the number and size of said detection zones is selected to provide an alternating detection response pattern which can achieve highly selective target presence recognition.

7. The metal detector of claim 1, further comprising a numerical processing function of said alternating polarity composite detection signal to identify the presence and/or composition of a target.

8. The metal detector of claim 7, wherein said numerical processing function further comprises processing capability to resolve the 180 degree phase ambiguity between positive and negative composite responses to identify the composition of a target as metallic or non-metallic.

9. The metal detector according to claim 1, wherein said detection coil signal scaling factors are adjustable such that the ability to null said composite detection signal response to an externally generated field is maintained.

10. The metal detector of claim 9 wherein said adjustments may be made at the point of manufacture, manually by the user and/or by an automated function while in service.

11. The metal detector of claim 10 wherein said automated function of adjustment is performed periodically, continuously, or by an EMI balance command actuated by the user.

12. The metal detector according to claim 1, wherein said detection zones comprise at least two different zone widths with corresponding differential sensitivity to depth.

13. The metal detector according to claim 1, wherein said composite detection signal is processed continually such that target information is also provided continuously without the necessity for stopping the detector motion relative to said target.

14. The metal detector according to claim 1, wherein mounting or adjustment of a long detection surface places it substantially orthogonal to the direction of search, thus enabling its use for forward motion searching rather than a side to side motion of the detection surface.

15. The metal detector according to claim 1, wherein mounting or adjustment of a long detection surface places it substantially in line with the direction of search, thus enabling its use as a swing type metal detector.

16. The metal detector according to claim 1, wherein the movement of said detector relative to a target due to movement of the coil apparatus by carriage by any mobile means, including but not limited to carriage by a human, bicycle, cart, trailer, or vehicle, including but not limited to air, water, submersible, or other vehicle which is powered by mechanical or human means.
